(19) United States
(12) Patent Application Publication
(10) Pub. No.: US 2013/0110798 A1
(43) Pub. Date: May 2, 2013

(54) INTERCEPTING AND PROCESSING DATABASE COMMANDS

(71) Applicants: Thomas W. Millett, Mill Creek, WA (US); Joseph T. Flint, Redmond, WA (US)

(72) Inventors: Thomas W. Millett, Mill Creek, WA (US); Joseph T. Flint, Redmond, WA (US)

(73) Assignee: Microsoft Corporation, Redmond, WA (US)

(21) Appl. No.: 13/282,802

(22) Filed: Oct. 27, 2011

(51) Int. Cl. G06F 17/30

(52) U.S. Cl. 707/705; 707/E17.001

(57) ABSTRACT

A hybrid approach that combines a small “native” shell and a rich web-based user-interface (UI) is used to develop an application. The shell portion includes a database adapter developed for the targeted platform. The web-based UI can be shared between different devices (mobile/non-mobile) that can host a web-browser. Once the UI has been developed it can be used across mobile devices and desktop devices. A database proxy/adaptor intercepts database calls to be performed on a database defined according to a first specification. The database calls are intercepted before they can be executed against the database. The database adapter processes the database calls to be performed against a different database. The results are returned to the caller as if the database command was performed following the first specification against the database identified in the database command.

### BACKGROUND

There are several ways to design an application for a mobile device. One way is to build the application entirely in code that is “native” to the device. When the code is native to the device, a different codebase is created for each targeted device. In this scenario, an application targeted for one type of phone would not be able to run on another type of phone. Other ways to design an application include using web technologies to design a user interface. Some web based applications are able to access a browser hosted database. For example, Web SQL Database by the W3C working group uses SQL to interact with client-side browser hosted databases. Other developers are also working on other client based web storage technologies. These web storage technologies, however, have their own limitations.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A hybrid approach that combines a small “native” shell and a rich web-based user-interface (UI) is used to develop an application. The shell portion includes a database adapter developed for the targeted platform. The web-based UI can be shared between different devices (mobile/non-mobile) that can host a web-browser. Once the UI has been developed it can be used across mobile devices and desktop devices. A database proxy/adaptor intercepts database calls to be performed on a database defined according to a first specification. The database calls are intercepted before they can be executed against the database. The database adapter processes the database calls to be performed against a different database. The results are returned to the caller as if the database command was performed following the first specification against the database identified in the database command.

### BRIEF DESCRIPTION OF THE DRAWINGS

FIG. 1 illustrates an exemplary computing device;

FIG. 2 illustrates an exemplary system that shows intercepting database calls before they are executed against a database;

FIG. 3 shows a process for intercepting and processing database commands before they are executed against a database; and

FIG. 4 shows a process for executing database commands before the database call is issued.

### DETAILED DESCRIPTION

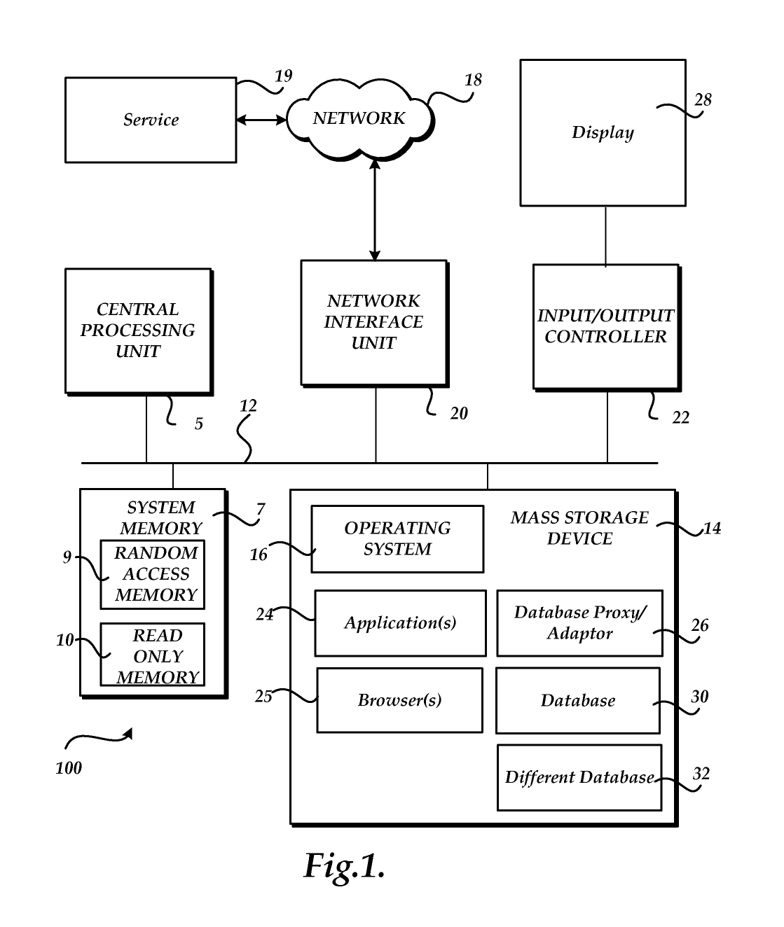

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a server computing device, a desktop computing device, a mobile computing device (e.g. smartphone, notebook, tablet . . . ) and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application(s) 24, and other program modules, such as Web browser 25, database proxy/adaptor 26, database 30 and different database 32.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, such as a touch input device. The touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device may also act as a display 28. The input/output controller 22 may also provide output to one or more display screens, a printer, or other type of output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, can be integrated with other components of the computing device/system 100 on the single integrated circuit (chip).

As mentioned briefly above, a number of program modules and data files may be stored in the mass storage device 14 and RAM 9 of the computer 100, including an operating system 16 suitable for controlling the operation of a networked personal computer, such as the WINDOWS SERVER®, WINDOWS 7® operating systems from MICROSOFT CORPORATION of Redmond, Wash.

The mass storage device 14 and RAM 9 may also store one or more program modules. In particular, the mass storage device 14 and the RAM 9 may store one or more applications 24, such as messaging applications, productivity applications, games and the like. Computing device 100 may store one or more Web browsers 25. The Web browser 25 is operative to request, receive, render, and provide interactivity with electronic documents, such as a Web page.

Database proxy/adaptor 26 is configured to intercept database calls made by an application that is hosted using web technologies. According to an embodiment, the database calls follow the specification as defined using the Web SQL Database API by the W3C working group. Other database calls following other specifications may be intercepted. The database adaptor 26 is developed for the target device. For example, a database adaptor may be developed for an APPLE device, a MICROSOFT device, a GOOGLE device, and the like.

The application is developed using the selected web technology (i.e. Web SQL database). The web-based UI can be shared between different devices (mobile/non-mobile) that can host a web-browser. Once the UI has been developed it can be used across mobile devices and desktop devices. The database proxy/adaptor intercepts database calls to be performed on a database defined according to selected web technology. The database calls are intercepted before they can be executed against the database. The database adapter designed for the targeted device processes the database calls to be performed against a different database. The results are returned to the caller as if the database command was performed following the first specification against the database identified in the database command. Additional details regarding the operation of the database proxy/adapter 26 will be provided below.

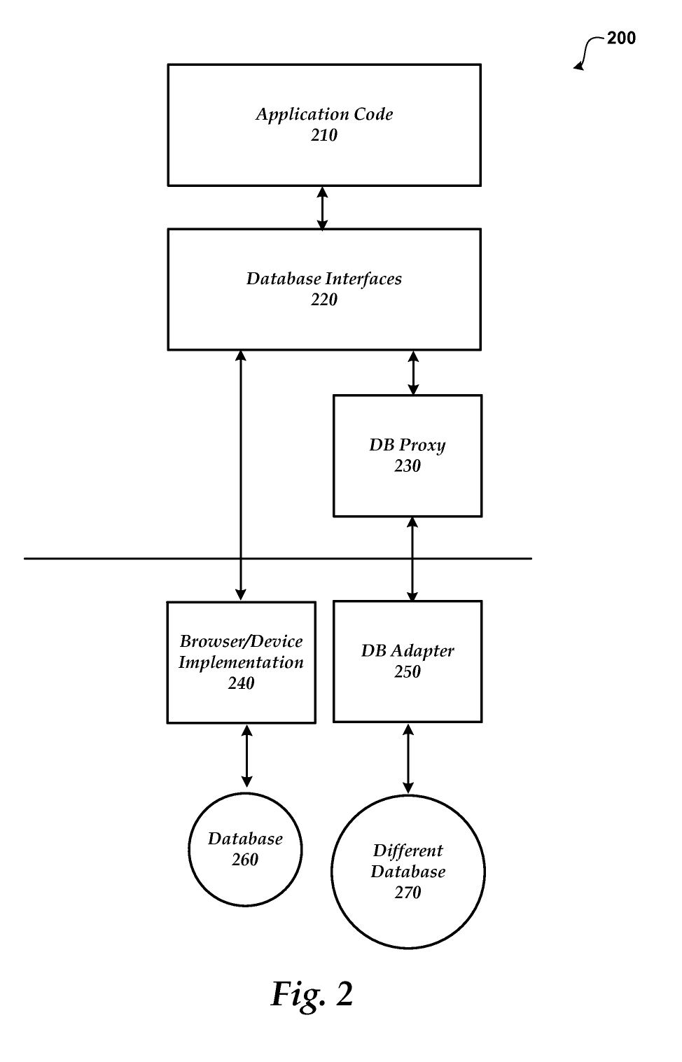

FIG. 2 illustrates an exemplary system that shows intercepting database calls before they are executed against a database. As illustrated, system 200 includes application UI code 210, database (DB) interfaces 220, DB proxy 230, DB adaptor 250, browser implementation 240, database 260 and different database 270.

According to an embodiment, the proxy 230 and adaptor 250 intercepts and processes database commands that generally follow the Web SQL Database API specified by the W3C working group. Many browsers (e.g. CHROME, SAFARI, OPERA and WEBKIT based mobile devices) support the Web SQL Database specification even though it is not adopted as a standard. Generally, Web SQL database allows a database to reside inside a browser. Instead of making AJAX calls back and forth between a server and client whenever any information is needed, the data is stored locally in the browser. Other web based technologies that integrate a browser with a database may be used.

Without intercepting the database calls and processing the database calls differently from the browser implementation, the database calls are dependent upon the browser implementation 240. Each implementation of a browser that follows the Web SQL Database API by the W3C working group may limit/restrict access to a database from the application. For example, a size of the data storage is limited, a limited set of commands may be provided to interact with the database, the database hosted by the browser may be tied to a specific web domain (e.g. www.123.com), and the like. For example, if a database is associated with www.123.com and a failover causes a switch to a different domain (e.g. failover.123.com) the web-based UI following the provided API would not be able to access the data stored in the database associated with www.123.com. The data would have to be recreated at the failover site and then when moved back to the original site it would have to be rebuilt again. Further, each browser may provide different restrictions/limitations making it difficult to use an application across different devices. For example, while one browser/device may allow a 10 mb database, another browser/device may only allow a 5 mb database even though the application requires a larger amount of space.

Some example database commands that may be intercepted and processed by proxy 230 and adaptor 250, include but are not limited to: opening a database, storing/deleting/querying data in the database, closing the database, and the like. The DB proxy 230 is configured to intercept each of the database calls made by the selected database interface used to interface with application code 210 and pass them automatically to DB adaptor 250. According to an embodiment, the DB proxy 230 intercepts calls associated with Web SQL database, including but not limited to: WindowDatabase, Database, SqlVoidCallback, SqlTransactionCallback, SqlTransactionErrorCallback, SqlStatementCallback, SqlStatementErrorCallback, SqlResultSet, SqlResultSetRowList, and SqlError.

DB adaptor 250 is configured to interact with a database, such as different database 270 and/or database 260. While database 260 and different database 270 are illustrated as separate databases they may be stored within a same native data store. Database 260, however, has restrictions/limitations that different database does not have. For example, different database 270 does not have a size restriction placed on it by the browser/device implementation 240.

DB adaptor 250 receives an intercepted command from DB proxy 230 and processes the database command to be executed against different database 270. According to an embodiment, DB adaptor 250 and DB Proxy are configured to emulate the processing of database commands as though it was using the browser/device implementation as specified by the selected web technology. For example, database commands may be queued before being submitted to a database. DB adaptor 250 may perform database commands differently from the browser/device implementation 240. For example, a database operation may be performed in parallel with the loading of script code for a browser, the different database 270 may be loaded in response to starting an application on a device before the database is requested, a database may be deleted and wiped clean, and the like. Intercepting and processing the database commands from the application help in allowing an application to be developed for use across platforms/devices without being limited by the browser/device implementation 240.

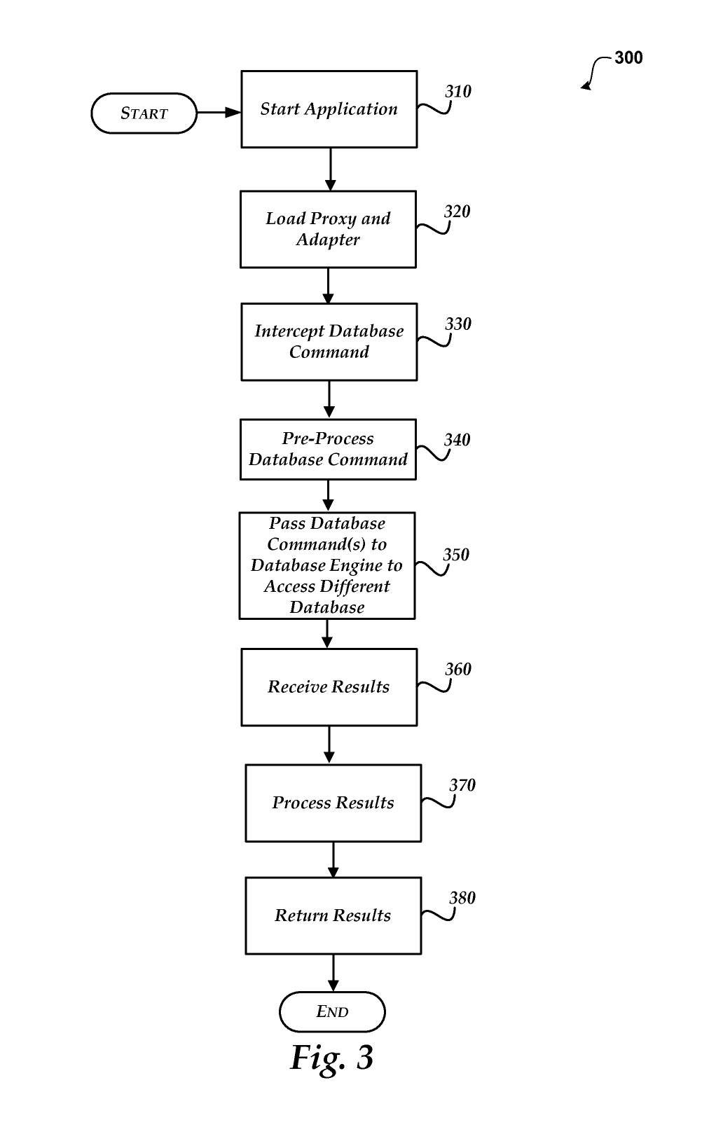

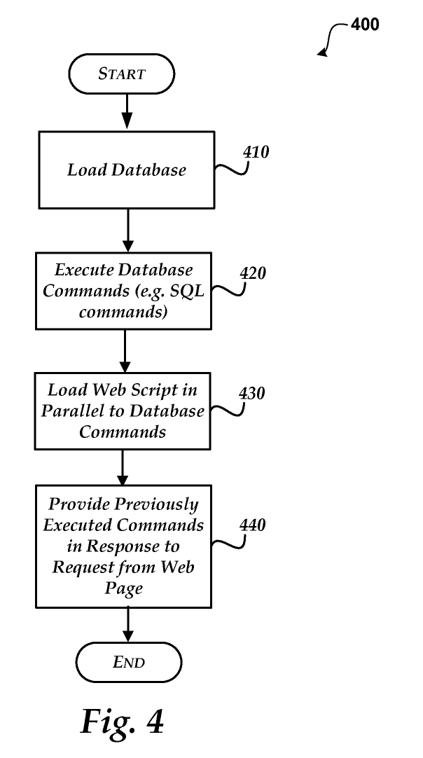

FIGS. 3 and 4 show illustrative processes for intercepting and processing database commands before they are processed using a default method that is associated with an API. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 3 shows a process for intercepting and processing database commands before they are executed against a database.

After a start operation, the process 300 flows to operation 310, where an application is started. According to an embodiment, the application is an application developed according to a cross-platform specification that includes a browser based database. For example, the cross-platform specification may be the Web SQL database specification by W3C.

Moving to operation 320, the proxy and adaptor are loaded. The proxy and adaptor may be loaded at the start of the application and/or at some other time before/after a database command is issued by the application but before the database command is executed against a database.

Flowing to operation 330, the database command is intercepted by the proxy and passed to the adaptor for processing. The database command is intercepted by the proxy before the database command is executed against the database identified within the database command. For example, the database command is intercepted before it is passed to the JavaScript, or some other language engine, that is associated with the application.

Transitioning to operation 340, the database command may be pre-processed. The pre-processing may be configured to perform various operations. The pre-processing may be configured to identify a different database to interact with as compared to the identified database that is restricted/limited by the device/browser implementation, the database command may be packaged with other database commands, and the like. For example, different optimizations may be configured based on properties that are associated with the different database/device (See FIG. 4 and related discussion).

Moving to operation 350, the processed database command(s) are passed to a database engine that accesses a different database (e.g. an unrestricted database that is not limited by the browser/device implementation of the selected web technology used to develop the application). The database engine may be the same database engine as would be used by an application that does not include a database adaptor and/or a different database engine.

Flowing to operation 360, the results are received from the database engine. The results are dependent upon the database command(s) executed.

Transitioning to operation 370, the results may be processed. For example, the results may be processed to emulate the results that would be returned based on the first specification.

Moving to operation 380, the results are returned to the caller. The caller may be unaware that the processing of the database command was different from the browser/device implementation.

The process then moves to an end operation and returns to processing other actions.

FIG. 4 shows a process for executing database commands before the database call is issued.

After a start operation, the process 400 flows to operation 410, where a database is loaded. The database may be loaded before it is identified by an issued database command. For example, the database may be identified and loaded upon starting an application (e.g. a messaging application may load a message database immediately upon starting the application). In this way, the database will be ready sooner than having to wait for the web page to be loaded and processed.

Moving to operation 420, database commands (e.g. SQL commands) may be executed against the database before they are issued by a web script.

Flowing to operation 430, the web script may be loaded in parallel to the database commands being executed against the database. This parallel loading helps in speeding up the availability of data to an application.

Transitioning to operation 440, the results to the previously executed database commands may be returned immediately in response to the database call being issued.

The process then moves to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for intercepting and processing database commands, comprising:
detecting a database command from a caller that requests an operation to be performed on a database that follows an Application Programming Interface (API) that is defined using a first specification;
intercepting the database command;
preventing the database command from being executed against the database;
processing the intercepted database command comprising identifying a different database from the database on which to perform the database command;
passing the processed intercepted database command to a database engine to perform the requested operation defined by the database command on the different database;
receiving results from the database engine; and
providing the results to the caller.

2. The method of claim 1, wherein the database command is issued by a web browser.

3. The method of claim 1, wherein intercepting the database command occurs before the database command reaches a language engine associated with a web page that issues the database command.

4. The method of claim 1, further comprising pre-processing the intercepted database command to emulate the processing of the database command as defined by the first specification.

5. The method of claim 1, wherein intercepting the database command comprises intercepting each received database command and automatically passing the database command to a database adapter that is coupled to the different database.

6. The method of claim 1, wherein each intercepted database call is performed on the different database.

7. The method of claim 1, further comprising processing a database command following the different specification before the database command is issued by a web browser.

8. The method of claim 1, further comprising loading the different database before the database associated with a database command is identified by a web browser.

9. The method of claim 1, further comprising pre-processing the results received by the database engine to emulate returned results following the first specification.

10. A computer-readable medium having computer-executable instructions for intercepting and processing database commands, comprising:
detecting a database command issued by a web browser that requests an operation to be performed on a database;
intercepting the database command;
preventing the database command from being executed against the database;
passing the database command to a database engine to perform the requested operation defined by the database command on a different database;
receiving results from the database engine;
pre-processing the results received by the database engine to emulate returned results following the first specification; and
providing the results to the caller.

11. The computer-readable medium of claim 10, wherein intercepting the database command occurs before the database command reaches a language engine associated with a web page that issues the database command.

12. The computer-readable medium of claim 10, wherein intercepting the database command comprises intercepting each received database command and automatically passing the database command to a database adapter that is coupled to the different database.

13. The computer-readable medium of claim 10, wherein each intercepted database call is performed on the different database.

14. The computer-readable medium of claim 10, further comprising processing a database command to perform an action on the different database before the database command is issued by a web browser.

15. The computer-readable medium of claim 10, further comprising loading the different database before the database is identified by a web browser.

16. A system for intercepting and processing database commands, comprising:
a database;
a different database;
a database engine configured to perform database commands;
a web-browser;
a processor and a computer-readable medium;
an operating environment stored on the computer-readable medium and executing on the processor; and
a database proxy/adaptor operating under the control of the operating environment and operative to:
detect a database command issued by the web browser that requests an operation to be performed on the database;
intercept the database command;
prevent the database command from being executed against the database;
pass the database command to the database engine to perform the requested operation defined by the database command on the different database;
receive results from the database engine; and
providing the results.

17. The system of claim 16, wherein intercepting the database command occurs before the database command reaches a language engine associated with the web page that issues the database command.

18. The system of claim 16, wherein each intercepted database call is performed on the different database.

19. The system of claim 16, further comprising processing a database command to perform an action on the different database before the database command is issued by the web browser.

20. The system of claim 16, further comprising loading the different database before the database is identified by the web browser.
